(19) United States
(12) Patent Application Publication
(10) Pub. No.: US 2011/0278781 A1
(43) Pub. Date: Nov. 17, 2011

(54) CLAMPING DEVICE WITH COAXIALLY ROTATING GRIPPER PAIR

(76) Inventor: Tai-Her YANG, Dzan-Hwa (TW)

(21) Appl. No.: 12/780,045

(22) Filed: May 14, 2010

(51) Int. Cl. B25B 1/20

(52) U.S. Cl. 269/266

(57) ABSTRACT

The present invention relates to a clamping device with coaxially rotating gripper pair, which is the clamping device for clamping desirable targets in various shapes, in which two coaxially rotating rotary grippers in sector type cylinder are installed at the same clamping surface in the clamping device, and are commonly installed at the same socket with sector type recessed cylindrical sliding surface of the clip jaw.

### BACKGROUND OF THE INVENTION

(a) Field of the Invention

The present invention relates to a clamping device for clamping parallel desirable target, or cylindrical desirable target, or spherical desirable target, or unusual shape desirable target, in which two coaxially rotating rotary grippers in sector type cylinder are installed at the same clamping surface in the clamping device, and are commonly installed at the same socket with sector type recessed cylindrical sliding surface of the clip jaw, in which the socket with sector type recessed cylindrical sliding surface of the clip jaw and the rotating axis of the rotary gripper present coaxial arc shape, and the clamping surface at the edge side of the two coaxially rotating rotary grippers in sector type cylinder is used for pressing the desirable target, while the arc back of the two rotary grippers is coupled to the arc coupling surface of the socket with sector type recessed cylindrical sliding surface of the clip jaw, thereby when the surface withstands the pressure from the clamped desirable target, it rotates with the shape of the clamped desirable target along the socket with sector type recessed cylindrical sliding surface of the clip jaw, thus the clamping surface at the side of the two coaxially rotating rotary grippers in sector type cylinder against the desirable target presents stable clamping status.

(b) Description of the Prior Art

When the conventional clamp clamps an unusual shape desirable target, the jig with the shape complementary to that of the desirable target is usually required for assistant, which has shortcomings of high cost and long production time; moreover for the clamping device constituted by being installed with two sector type grippers at the same clip jaw, because of the different axes of the two sector type grippers, there is a gap between two neighboring grippers when rotating, thus a desirable target (120) with smaller diameter cannot be effectively clamped (as shown in FIG. 1).

### SUMMARY OF THE INVENTION

The present invention relates to a clamping device with coaxially rotating gripper pair, which is the clamping device for clamping desirable targets in various shapes, in which two coaxially rotating rotary grippers in sector type cylinder are installed at the same clamping surface in the clamping device, and are commonly installed at the same socket with sector type recessed cylindrical sliding surface of the clip jaw, in which the socket with sector type recessed cylindrical sliding surface of the clip jaw and the rotating axis of the rotary gripper present coaxial arc shape, and the clamping surface at the edge side of the two coaxially rotating rotary grippers in sector type cylinder is used for pressing the desirable target, while the arc back of the two rotary grippers is coupled to the arc coupling surface of the socket with sector type recessed cylindrical sliding surface of the clip jaw, thereby when the surface withstands the pressure from the clamped desirable target, it rotates with the shape of the clamped desirable target along the socket with sector type recessed cylindrical sliding surface of the clip jaw, thus the clamping surface at the side of the two coaxially rotating rotary grippers in sector type cylinder against the desirable target presents stable clamping status.

### BRIEF DESCRIPTION OF THE DRAWINGS

FIG. 1 shows the dilemma for the grippers of the conventional clamping device formed through the same clip jaw being installed with a sector type gripper pair clamping a cylinder with smaller diameter;

FIG. 2 is a schematic view showing the main structure of the principles of the present invention;

FIG. 3 is a schematic view showing the first status of two coaxially rotating rotary grippers in sector type cylinder (101) and (102) of the present invention clamping a cylinder desirable target with smaller diameter;

FIG. 4 is a schematic view showing the second status of two coaxially rotating rotary grippers in sector type cylinder (101) and (102) of the present invention clamping an asymmetric polyhedron desirable target;

FIG. 5 is the first applied structural embodiment of the present invention;

FIG. 6 is the second applied structural embodiment of the present invention;

FIG. 7 is the 3rd applied structural embodiment of the present invention;

FIG. 8 is the 4th applied structural embodiment of the present invention;

FIG. 9 is the 5th applied structural embodiment of the present invention;

FIG. 10 is the 6th applied structural embodiment of the present invention;

FIG. 11 is the 7th applied structural embodiment of the present invention;

FIG. 12 is the 8th applied structural embodiment of the present invention;

FIG. 13 is the 9th applied structural embodiment of the present invention;

FIG. 14 is the 10th applied structural embodiment of the present invention;

FIG. 15 is the 11th applied structural embodiment of the present invention;

FIG. 16 is the 12th applied structural embodiment of the present invention;

FIG. 17 is the 13th applied structural embodiment of the present invention;

FIG. 18 is the 14th applied structural embodiment of the present invention;

FIG. 19 is the 15th applied structural embodiment of the present invention;

FIG. 20 is the 16th applied structural embodiment of the present invention;

FIG. 21 is the 17th applied structural embodiment of the present invention;

FIG. 22 is the 18th applied structural embodiment of the present invention;

FIG. 23 is the 19th applied structural embodiment of the present invention; and

FIG. 24 is the 20th applied structural embodiment of the present invention.

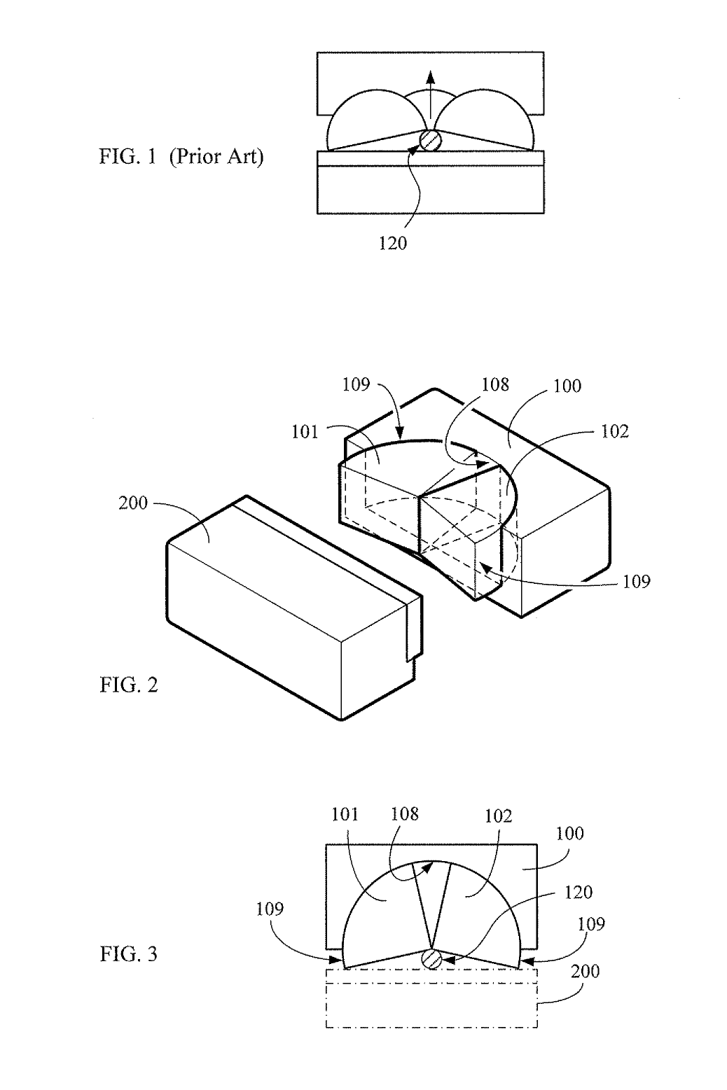

### DESCRIPTION OF MAIN COMPONENT SYMBOLS

100, 300, 400, 500: Clip jaw

101, 102: Two coaxially rotating rotary grippers in sector type cylinder

108, 308, 408, 508: Socket with sector type recessed cylindrical sliding surface

109: Arc-shaped coupling surface

120: Desirable target

200: Fixed shape clamping structure

301, 302, 401: Sector type gripper

311, 312, 511: Sector type middle gripper

318, 518: Middle socket with sector type recessed cylindrical sliding surface

### DETAILED DESCRIPTION OF THE PREFERRED EMBODIMENTS

The present invention relates to a clamping device for clamping desirable targets in various shapes, in which two coaxially rotating rotary grippers in sector type cylinder are installed at the same clamping surface in the clamping device, and are commonly installed at the same socket with sector type recessed cylindrical sliding surface of the clip jaw, in which the socket with sector type recessed cylindrical sliding surface of the clip jaw and the rotating axis of the rotary gripper present coaxial arc shape, and the clamping surface at the edge side of the two coaxially rotating rotary grippers in sector type cylinder is used for pressing the desirable target, while the arc back of the two rotary grippers is coupled to the arc coupling surface of the socket with sector type recessed cylindrical sliding surface of the clip jaw, thereby when the surface withstands the pressure from the clamped desirable target, it rotates with the shape of the clamped desirable target along the socket with sector type recessed cylindrical sliding surface of the clip jaw, thus the clamping surface at the side of the two coaxially rotating rotary grippers in sector type cylinder against the desirable target presents stable clamping status.

The definition of the sector of the present invention is a circular sector of an incomplete circle with an included angle less than 180 degrees and more than 0 degree.

FIG. 2 is a schematic view showing the main structure of the principles of the present invention.

As shown in FIG. 2, the main components include:
clip jaw (100): related to a fixed or clamped removable structure, in which one or more sockets with sector type recessed cylindrical sliding surfaces (108) are placed at the position facing the clamping surface, the socket with sector type recessed cylindrical sliding surface (108) is installed with two coaxially rotating rotary grippers in sector type cylinder (101) and (102), and has the arc-shaped coupling surface (109) for the two coaxially rotating rotary grippers in sector type cylinder (101) and (102) to rotate coaxially, the rotating axis of the socket with sector type recessed cylindrical sliding surface (108) of the clip jaw and the two coaxially rotating rotary grippers in sector type cylinder (101) and (102) presents coaxial arc-shape, and forms the moving coupling and the restrictive structure of the two coaxially rotating rotary grippers in sector type cylinder (101) and (102); and
two coaxially rotating rotary grippers in sector type cylinder (101) and (102): constituted by sector type cylinder, and installed at the socket with sector type recessed cylindrical sliding surface (108) of the clip jaw for coaxial rotation, in which the two coaxially rotating rotary grippers in sector type cylinder (101) and (102) are partial cylinders with same or different angles, and are installed at the same rotating axis at the socket with sector type recessed cylindrical sliding surface (108) of the clip jaw, and couple to the socket with sector type recessed cylindrical sliding surface (108) of the clip jaw (100) to rotate at the same axis.

For the clamping device with coaxially rotating gripper pair, through the operations of the two coaxially rotating rotary grippers in sector type cylinder (101) and (102) of the structure shown in FIG. 2, the embodiments of clamping operations are as following.

FIG. 3 is a schematic view showing the first status of two coaxially rotating rotary grippers in sector type cylinder (101) and (102) of the present invention clamping a cylinder desirable target with smaller diameter (120).

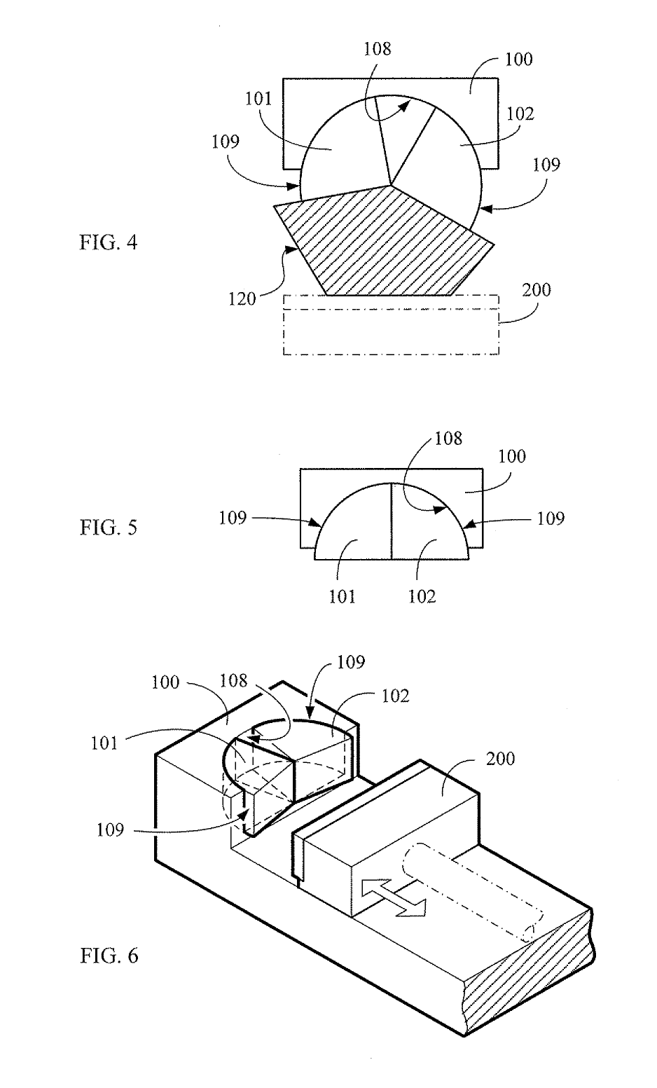

FIG. 4 is a schematic view showing the second status of two coaxially rotating rotary grippers in sector type cylinder (101) and (102) of the present invention clamping an asymmetric polyhedron desirable target (120).

The practical applications of the clamping device with coaxially rotating gripper pair of the present invention include:

1. the two coaxially rotating rotary grippers in sector type cylinder (101) and (102) constitute the clamping device, and one or more of the above clamping devices cater for the structure of the desirable target (FIG. 5 is the first applied structural embodiment of the present invention);

2. the two coaxially rotating rotary grippers in sector type cylinder (101) and (102) constitute the clamping device, and one or more of the above clamping devices together with one fixed shape clamping structure (200) constitute the structure with clamping function (FIG. 6 is the second applied structural embodiment of the present invention);

3. the two coaxially rotating rotary grippers in sector type cylinder (101) and (102) constitute the clamping device, and two of the above clamping devices clamp in opposite to form the structure with clamping function (FIG. 7 is the 3rd applied structural embodiment of the present invention);

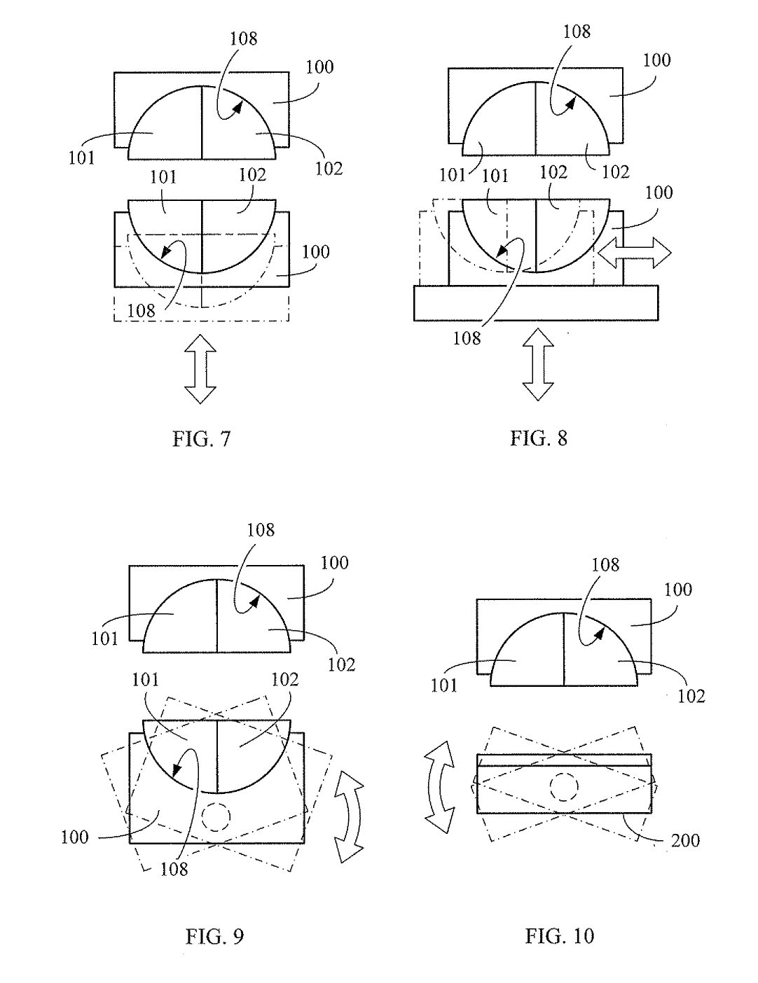

4. the two coaxially rotating rotary grippers in sector type cylinder (101) and (102) constitute the clamping device, and two of the above clamping devices clamp in opposite, in which at least one clamping device has the clip jaw with the function of lateral movement at near to 90 degrees with the clamping direction (FIG. 8 is the 4th applied structural embodiment of the present invention);

5. the two coaxially rotating rotary grippers in sector type cylinder (101) and (102) constitute the clamping device, and two of the above clamping devices clamp in opposite, in which one clamping device swings along the direction of clamping movement to make angular displacement, thereby to form the structure with clamping function (FIG. 9 is the 5th applied structural embodiment of the present invention);

6. the two coaxially rotating rotary grippers in sector type cylinder (101) and (102) constitute the clamping device, one of the above clamping device and a clamping device with fixed shape clamp in opposite, and one of the two clamping devices swings along the direction of clamping movement to make angular displacement, thereby to form the structure with clamping function (FIG. 10 is the 6th applied structural embodiment of the present invention);

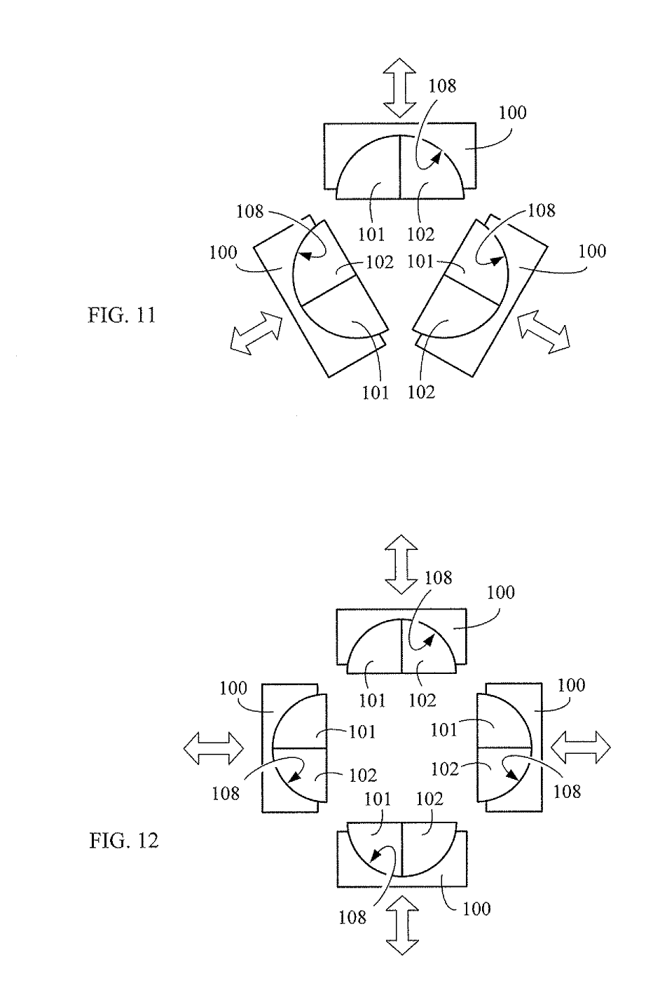

7. the two coaxially rotating rotary grippers in sector type cylinder (101) and (102) constitute the clamping device, and three of the above clamping devices, with angular difference of 120 degrees, respectively, form the structure with tripartite clamping function, in which the maximum operational included angle between the two neighboring clamping devices is less than or equals to 180 degrees (FIG. 11 is the 7th applied structural embodiment of the present invention);

8. the two coaxially rotating rotary grippers in sector type cylinder (101) and (102) constitute the clamping device, and four of the above clamping devices, with angular difference of 90 degrees, respectively, form the structure with tetrapartite clamping function, in which the maximum operational included angle between the two neighboring clamping devices is less than or equals to 180 degrees (FIG. 12 is the 8th applied structural embodiment of the present invention);

9. the two coaxially rotating rotary grippers in sector type cylinder (101) and (102) constitute the clamping device, and more than four of the above clamping devices form the structure with multi-direction clamping function;

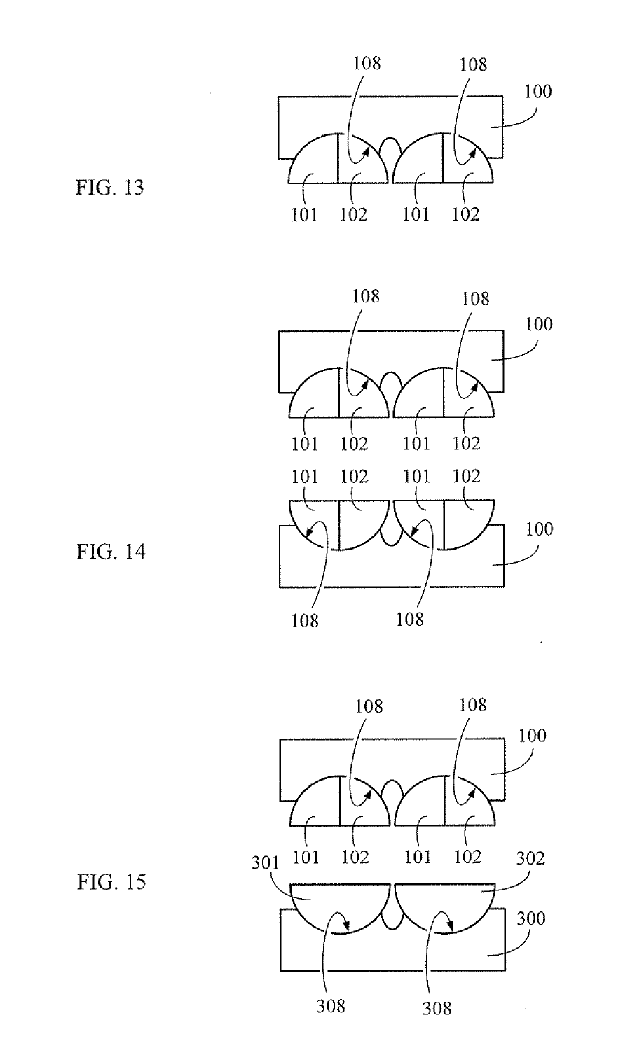

10. two sets of two coaxially rotating rotary grippers in sector type cylinder (101) and (102) are individually installed at two sockets with sector type recessed cylindrical sliding surfaces (108) of the same clip jaw to form the clamping device with clamping function (FIG. 13 is the 9th applied structural embodiment of the present invention);

11. two sets of two coaxially rotating rotary grippers in sector type cylinder (101) and (102) are individually installed at two sockets with sector type recessed cylindrical sliding surfaces (108) of the same clip jaw to form the clamping device with clamping function, and two of the above clamping devices constitute the structure for opposite clamping (FIG. 14 is the 10th applied structural embodiment of the present invention);

12. two sets of two coaxially rotating rotary grippers in sector type cylinder (101) and (102) are individually installed at two sockets with sector type recessed cylindrical sliding surfaces (108) of the same clip jaw to form the clamping device with clamping function; and one of the above clamping device and one clamping device constituted by the clip jaw installed with two sector type grippers (301), (302) and two sockets with sector type recessed cylindrical sliding surface (308) of the clip jaw (300) constitute the structure for opposite clamping (FIG. 15 is the 11th applied structural embodiment of the present invention);

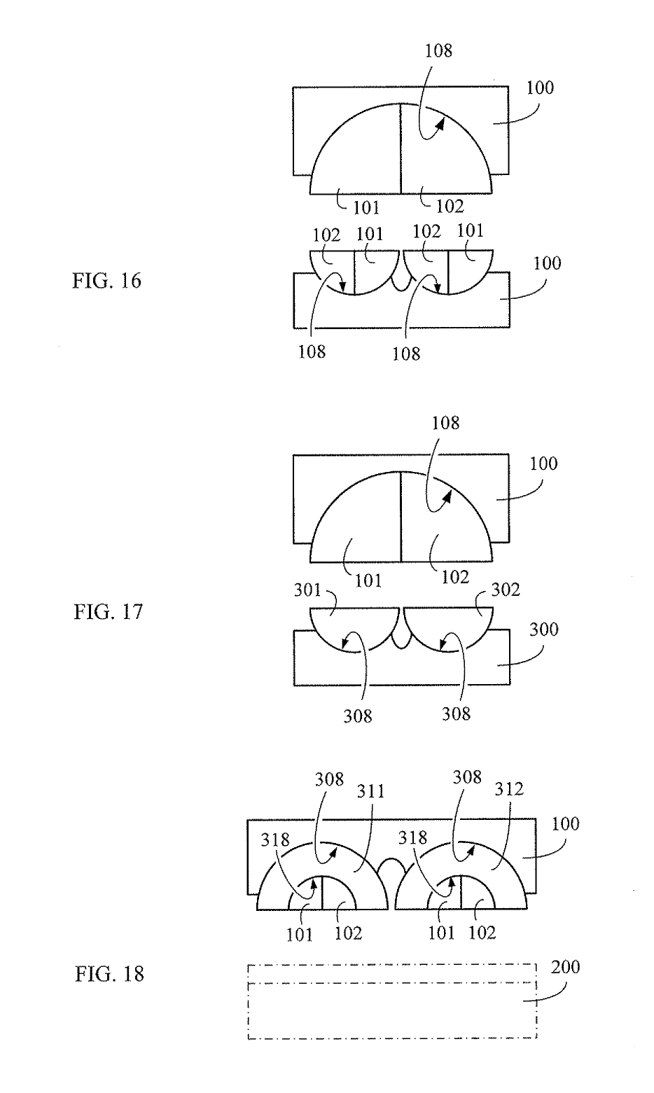

13. two sets of two coaxially rotating rotary grippers in sector type cylinder (101) and (102) are individually installed at two sockets with sector type recessed cylindrical sliding surfaces (108) of the same clip jaw to form the clamping device with clamping function; one of the above clamping device, and one clamping device installed with one socket with sector type recessed cylindrical sliding surface (108) with two coaxially rotating rotary grippers in sector type cylinder (101) and (102) constitute the structure for opposite clamping (FIG. 16 is the 12th applied structural embodiment of the present invention);

14. one clamping device installed with one socket with sector type recessed cylindrical sliding surface (108) and two coaxially rotating cylinder rotary grippers (101) and (102), which are smaller than the sector, and one clamping device constituted by a clip jaw (300) installed with two sector type grippers (301), (302) and two sockets with sector type recessed cylindrical sliding surfaces (308) constitute the structure for opposite clamping (FIG. 17 is the 13th applied structural embodiment of the present invention);

15. two sector type middle grippers (311) and (312) couple to two sockets with sector type recessed cylindrical sliding surfaces (308) installed at the clip jaw (100), the sector type middle grippers (311) and (312) individually has a middle socket with sector type recessed cylindrical sliding surface (318) on the clamping surface, in which each middle socket with sector type recessed cylindrical sliding surface (318) is individually installed with two coaxially rotating rotary grippers in sector type cylinder (101) and (102), whose diameters are smaller, and the clamping surfaces at two sides of the sector type middle grippers (311) and (312) and the clamping surface of the two coaxially rotating rotary grippers in sector type cylinder (101) and (102) together constitute the clamping device with clamping function, and thereby the clamping device and another clamping device with fixed shape constitute the clamping structure (FIG. 18 is the 14th applied structural embodiment of the present invention);

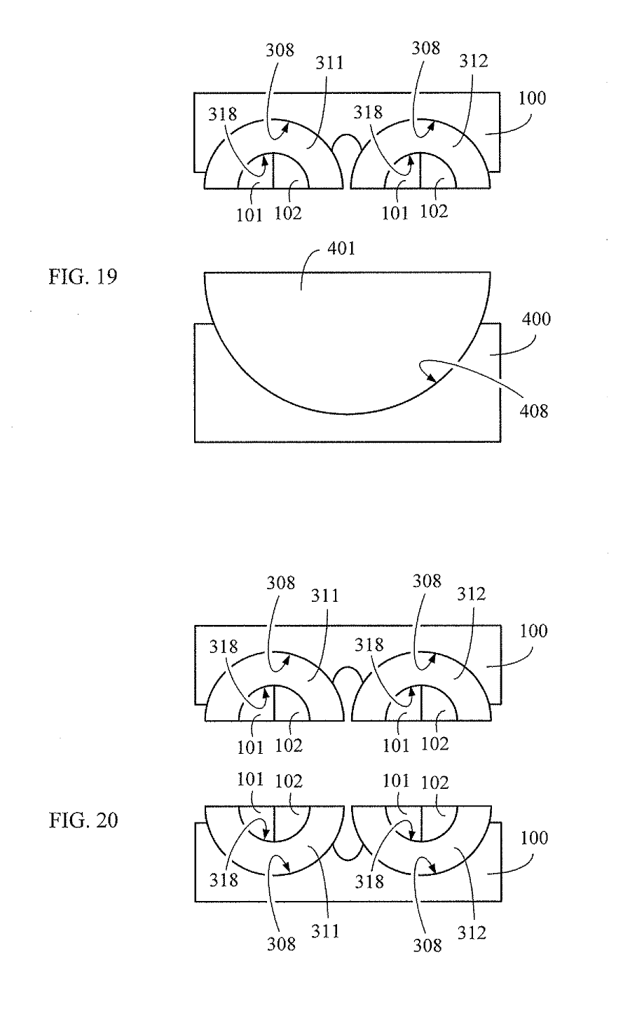

16. two sector type middle grippers (311) and (312) couple to two sockets with sector type recessed cylindrical sliding surfaces (308) installed at the clip jaw (100), the sector type middle grippers (311) and (312) individually has a middle socket with sector type recessed cylindrical sliding surface (318) on the clamping surface, in which each middle socket with sector type recessed cylindrical sliding surface (318) is individually installed with two coaxially rotating rotary grippers in sector type cylinder (101) and (102), whose diameters are smaller, and the clamping surfaces at two sides of the sector type middle grippers (311) and (312) and the clamping surface of the two coaxially rotating rotary grippers in sector type cylinder (101) and (102) together constitute the clamping device with clamping function, while another clamping device is constituted by a clip jaw (400) with a socket with sector type recessed cylindrical sliding surface (408) and a coupled sector type gripper (401), and thereby said two clamping devices constitute the structure for opposite clamping (FIG. 19 is the 15th applied structural embodiment of the present invention);

17. two sector type middle grippers (311) and (312) couple to two sockets with sector type recessed cylindrical sliding surfaces (308) installed at the clip jaw (100), the sector type middle grippers (311) and (312) individually has a middle socket with sector type recessed cylindrical sliding surface (318) on the clamping surface, in which each middle socket with sector type recessed cylindrical sliding surface (318) is individually installed with two coaxially rotating rotary grippers in sector type cylinder (101) and (102), whose diameters are smaller, and the clamping surfaces at two sides of the sector type middle grippers (311) and (312) and the clamping surface of the two coaxially rotating rotary grippers in sector type cylinder (101) and (102) together constitute the clamping device with clamping function, and thereby the clamping device and another clamping device with the same structure constitute the structure for opposite clamping (FIG. 20 is the 16th applied structural embodiment of the present invention);

18. two sector type middle grippers (311) and (312) couple to two sockets with sector type recessed cylindrical sliding surfaces (308) installed at the clip jaw (100), the sector type middle grippers (311) and (312) individually has a middle socket with sector type recessed cylindrical sliding surface (318) on the clamping surface, in which each middle socket with sector type recessed cylindrical sliding surface (318) is individually installed with two coaxially rotating rotary grippers in sector type cylinder (101) and (102), whose diameters are smaller, and the clamping surfaces at two sides of the sector type middle grippers (311) and (312) and the clamping surface of the two coaxially rotating rotary grippers in sector type cylinder (101) and (102) together constitute the clamping device with clamping function, while another clamping device is constituted by a sector type middle gripper (511) couples to and rotates at a socket with sector type recessed cylindrical sliding surface (508) installed at a clip jaw (500), in which the clamping surface of the sector type middle gripper (511) has a middle socket with sector type recessed cylindrical sliding surface (518) for being installed with two coaxially rotating rotary grippers in sector type cylinder (101) and (102), whose diameters are smaller, and the clamping surface at two sides of the sector type middle gripper (511) and the clamping surface installed at the two coaxially rotating rotary grippers in sector type cylinder (101) and (102) of the middle socket with sector type recessed cylindrical sliding surface (518) together constitute the clamping device with clamping function, and thereby said two clamping devices constitute the structure for opposite clamping (FIG. 21 is the 17th applied structural embodiment of the present invention);

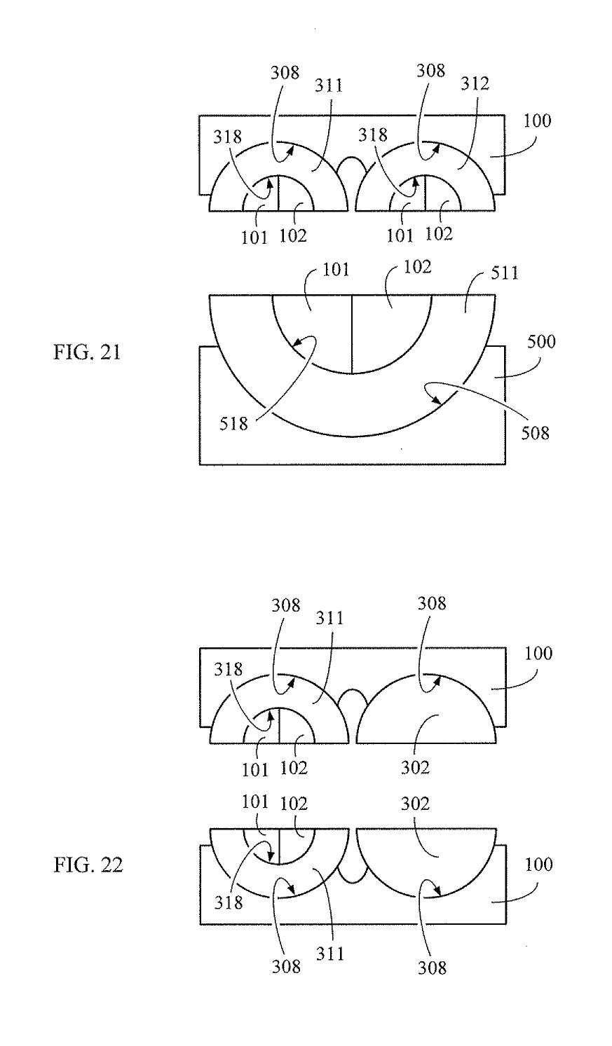

19. the sector type middle gripper (311) couples to one of the two sockets with sector type recessed cylindrical sliding surfaces (308) installed at the clip jaw (100), the other socket with sector type recessed cylindrical sliding surface (308) is installed with the sector type gripper (302), and the clamping surface of the sector type middle gripper (311) has the middle socket with sector type recessed cylindrical sliding surface (318), in which the middle socket with sector type recessed cylindrical sliding surface (318) is installed with two coaxially rotating rotary grippers in sector type cylinder (101) and (102), whose diameters are smaller, and the clamping surface of the sector type middle gripper (311), the clamping surface of the two coaxially rotating rotary grippers in sector type cylinder (101) and (102), and the sector type gripper (302) together constitute the clamping device with clamping function, and said clamping device and another clamping device installed with the same clamping device at the clamping surface thereof are arranged in opposite, i.e. the clamping surfaces of the two sector type grippers (302) clamp in opposite, and the clamping surfaces of the sector type middle gripper (311), the two coaxially rotating rotary grippers in sector type cylinder (101) and the two coaxially rotating sector type cylinder rotary grippers (102) clamp in opposite, and thereby two clamping devices constitute the structure for opposite clamping (FIG. 22 is the 18th applied structural embodiment of the present invention);

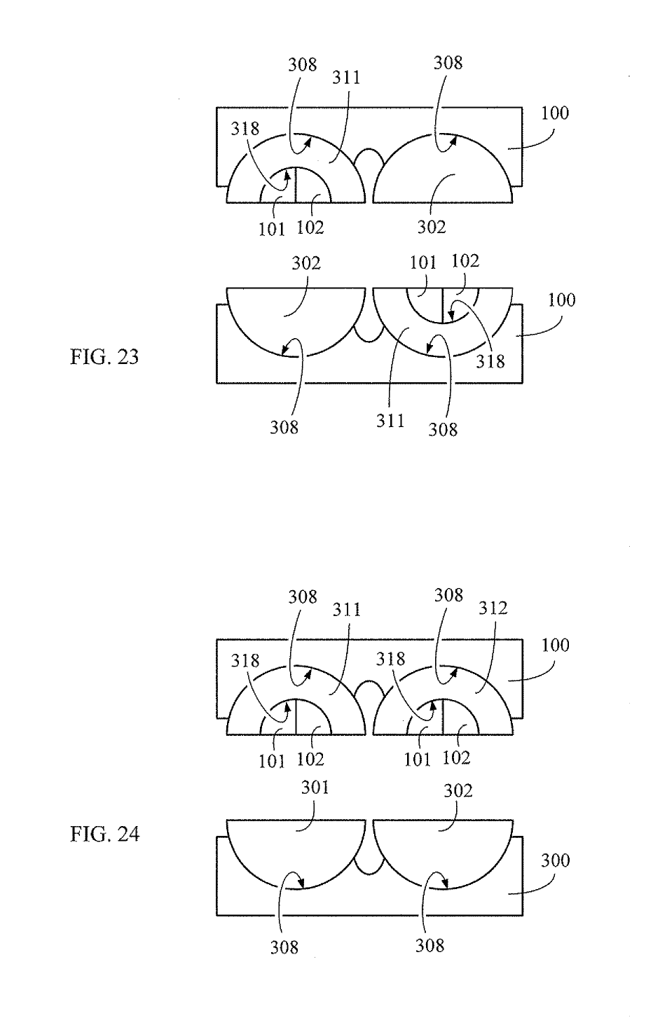

20. the sector type middle gripper (311) couples to one of the two sockets with sector type recessed cylindrical sliding surfaces (308) installed at the clip jaw (100), and the other socket with sector type recessed cylindrical sliding surface (308) installed at the clip jaw (100) is installed with the sector type gripper (302), and the clamping surface of the sector type middle gripper (311) has the middle socket with sector type recessed cylindrical sliding surface (318), in which the middle socket with sector type recessed cylindrical sliding surface (318) is individually installed with two coaxially rotating rotary grippers in sector type cylinder (101) and (102), whose diameters are smaller, and the clamping surface of the sector type middle gripper (311), the clamping surface of the two coaxially rotating rotary grippers in sector type cylinder (101) and (102), and the sector type gripper (302) together constitute the clamping device with clamping function, and said clamping device and another clamping device installed with the sector type gripper (302), the sector type middle gripper (311) and the two coaxially rotating rotary grippers in sector type cylinder (101) and (102), which is in opposite placement to said clamping device, at the opposite clamping surface thereof, i.e. the clamping surfaces of the sector type grippers (302) of the two clamping devices are respectively arranged to opposite clamp with the clamping surfaces at two sides of the sector type middle grippers (311) and the clamping surfaces of the two coaxially rotating rotary grippers in sector type cylinder (101) and (102), and thereby the two clamping devices constitute the structure for opposite clamping (FIG. 23 is the 19th applied structural embodiment of the present invention); and

21. two sector type middle grippers (311) and (312) couple to two sockets with sector type recessed cylindrical sliding surfaces (308) installed at the clip jaw (100), the sector type middle grippers (311) and (312) individually has a middle socket with sector type recessed cylindrical sliding surface (318) on the clamping surface, in which each middle socket with sector type recessed cylindrical sliding surface (318) is individually installed with two coaxially rotating rotary grippers in sector type cylinder (101) and (102), whose diameters are smaller, and the clamping surfaces at two sides of the sector type middle grippers (311) and (312) and the clamping surfaces of the two coaxially rotating rotary grippers in sector type cylinder (101) and (102) together constitute the clamping device with clamping function, and another clamping device is constituted by the clip jaw (300) installed with two sockets with sector type recessed cylindrical sliding surfaces (308), which is individually coupled with the sector type grippers (301) and (302), and thereby the two clamping devices constitute the structure for opposite clamping (FIG. 24 is the 20th applied structural embodiment of the present invention).

For the clip jaw (100) of the clamping device with coaxially rotating gripper pair, which is installed with the two coaxially rotating rotary grippers in sector type cylinder (101) and (102), the moving coupling and restrictive structure of the two coaxially rotating rotary grippers in sector type cylinder (101) and (102) includes to use the moving coupling and the restrictive structure of the conventional sector type gripper and the socket with sector type recessed cylindrical sliding surface of the clip jaw, such as the structure of curved guide slot and limited pin.

The clamping device with coaxially rotating gripper pair includes the clamping structural unit constituted by the clip jaw and the two coaxially rotating rotary grippers in sector type cylinder (101) and (102) to be integrated with the clamping surface of the clamping device for clamping operation.

The clamping device with coaxially rotating gripper pair includes the gripper driven by human power, or hydraulic, pneumatic, or mechanical power, or electricity.

The clamping device with coaxially rotating gripper pair includes to be applied to the clamping structure, such as the clamp, gripping structure, pressurized construction, pliers, pipe clamp, hand-held gripping tool, mechanical arm, or is used for the supporting device of the unusual shape body.

For the clamping device with coaxially rotating gripper pair, the clip jaw includes fixed or movable clip jaw, such as the clip jaw with fixed angle type structure and/or horizontally sliding clip jaw.

1. A clamping device with coaxially rotating gripper pair for clamping desirable targets in various shapes, wherein two coaxially rotating rotary grippers in sector type cylinder are installed at the same clamping surface in the clamping device, and are commonly installed at the same socket with sector type recessed cylindrical sliding surface of the clip jaw, in which the socket with sector type recessed cylindrical sliding surface of the clip jaw and the rotating axis of the rotary gripper present coaxial arc shape, and the clamping surface at the edge side of the two coaxially rotating rotary grippers in sector type cylinder is used for pressing the desirable target, while the arc back of the two rotary grippers is coupled to the arc coupling surface of the socket with sector type recessed cylindrical sliding surface of the clip jaw, thereby when the surface withstands the pressure from the clamped desirable target, it rotates with the shape of the clamped desirable target along the socket with sector type recessed cylindrical sliding surface of the clip jaw, thus the clamping surface at the side of the two coaxially rotating rotary grippers in sector type cylinder against the desirable target presents stable clamping status; and the main components include:
clip jaw (100): related to a fixed or clamped removable structure, in which one or more sockets with sector type recessed cylindrical sliding surfaces (108) are placed at the position facing the clamping surface, the socket with sector type recessed cylindrical sliding surface (108) is installed with two coaxially rotating rotary grippers in sector type cylinder (101) and (102), and has the arc-shaped coupling surface (109) for the two coaxially rotating rotary grippers in sector type cylinder (101) and (102) to rotate coaxially, the rotating axis of the socket with sector type recessed cylindrical sliding surface (108) of the clip jaw and the two coaxially rotating rotary grippers in sector type cylinder (101) and (102) presents coaxial arc-shape, and forms the moving coupling and the restrictive structure of the two coaxially rotating rotary grippers in sector type cylinder (101) and (102); and
two coaxially rotating rotary grippers in sector type cylinder (101) and (102): constituted by sector type cylinder, and installed at the socket with sector type recessed cylindrical sliding surface (108) of the clip jaw for coaxial rotation, in which the two coaxially rotating rotary grippers in sector type cylinder (101) and (102) are partial cylinders with same or different angles, and are installed at the same rotating axis at the socket with sector type recessed cylindrical sliding surface (108) of the clip jaw, and couple to the socket with sector type recessed cylindrical sliding surface (108) of the clip jaw (100) to rotate at the same axis.

2. The clamping device with coaxially rotating gripper pair as claimed in claim 1, wherein the two coaxially rotating rotary grippers in sector type cylinder (101) and (102) constitute the clamping device, and one or more of the above clamping devices cater for the structure of the desirable target.

3. The clamping device with coaxially rotating gripper pair as claimed in claim 1, wherein the two coaxially rotating rotary grippers in sector type cylinder (101) and (102) constitute the clamping device, and one or more of the above clamping devices together with one fixed shape clamping structure (200) constitute the structure with clamping function.

4. The clamping device with coaxially rotating gripper pair as claimed in claim 1, wherein the two coaxially rotating rotary grippers in sector type cylinder (101) and (102) constitute the clamping device, and two of the above clamping devices clamp in opposite to form the structure with clamping function.

5. The clamping device with coaxially rotating gripper pair as claimed in claim 1, wherein the two coaxially rotating rotary grippers in sector type cylinder (101) and (102) constitute the clamping device, and two of the above clamping devices clamp in opposite, in which at least one clamping device has the clip jaw with the function of lateral movement at near to 90 degrees with the clamping direction.

6. The clamping device with coaxially rotating gripper pair as claimed in claim 1, wherein the two coaxially rotating rotary grippers in sector type cylinder (101) and (102) constitute the clamping device, and two of the above clamping devices clamp in opposite, in which one clamping device swings along the direction of clamping movement to make angular displacement, thereby to form the structure with clamping function.

7. The clamping device with coaxially rotating gripper pair as claimed in claim 1, wherein the two coaxially rotating rotary grippers in sector type cylinder (101) and (102) constitute the clamping device, one of the above clamping device and a clamping device with fixed shape clamp in opposite, and one of the two clamping devices swings along the direction of clamping movement to make angular displacement, thereby to form the structure with clamping function.

8. The clamping device with coaxially rotating gripper pair as claimed in claim 1, wherein the two coaxially rotating rotary grippers in sector type cylinder (101) and (102) constitute the clamping device, and three of the above clamping devices, with angular difference of 120 degrees, respectively, form the structure with tripartite clamping function, in which the maximum operational included angle between the two neighboring clamping devices is less than or equals to 180 degrees.

9. The clamping device with coaxially rotating gripper pair as claimed in claim 1, wherein the two coaxially rotating rotary grippers in sector type cylinder (101) and (102) constitute the clamping device, and four of the above clamping devices, with angular difference of 90 degrees, respectively, form the structure with tetrapartite clamping function, in which the maximum operational included angle between the two neighboring clamping devices is less than or equals to 180 degrees.

10. The clamping device with coaxially rotating gripper pair as claimed in claim 1, wherein the two coaxially rotating rotary grippers in sector type cylinder (101) and (102) constitute the clamping device, and more than four of the above clamping devices form the structure with multi-direction clamping function.

11. The clamping device with coaxially rotating gripper pair as claimed in claim 1, wherein two sets of two coaxially rotating rotary grippers in sector type cylinder (101) and (102) are individually installed at two sockets with sector type recessed cylindrical sliding surfaces (108) of the same clip jaw to form the clamping device with clamping function.

12. The clamping device with coaxially rotating gripper pair as claimed in claim 1, wherein two sets of two coaxially rotating rotary grippers in sector type cylinder (101) and (102) are individually installed at two sockets with sector type recessed cylindrical sliding surfaces (108) of the same clip jaw to form the clamping device with clamping function, and two of the above clamping devices constitute the structure for opposite clamping.

13. The clamping device with coaxially rotating gripper pair as claimed in claim 1, wherein two sets of two coaxially rotating rotary grippers in sector type cylinder (101) and (102) are individually installed at two sockets with sector type recessed cylindrical sliding surfaces (108) of the same clip jaw to form the clamping device with clamping function; and one of the above clamping device and one clamping device constituted by the clip jaw installed with two sector type grippers (301), (302) and two sockets with sector type recessed cylindrical sliding surface (308) of the clip jaw (300) constitute the structure for opposite clamping.

14. The clamping device with coaxially rotating gripper pair as claimed in claim 1, wherein two sets of two coaxially rotating rotary grippers in sector type cylinder (101) and (102) are individually installed at two sockets with sector type recessed cylindrical sliding surfaces (108) of the same clip jaw to form the clamping device with clamping function; one of the above clamping device, and one clamping device installed with the socket with sector type recessed cylindrical sliding surface (108) with two coaxially rotating rotary grippers in sector type cylinder (101) and (102) constitute the structure for opposite clamping.

15. The clamping device with coaxially rotating gripper pair as claimed in claim 1, wherein one clamping device installed with one socket with sector type recessed cylindrical sliding surface (108) and two coaxially rotating cylinder rotary grippers (101) and (102), which are smaller than the sector, and one clamping device constituted by a clip jaw (300) installed with two sector type grippers (301), (302) and two sockets with sector type recessed cylindrical sliding surfaces (308) constitute the structure for opposite clamping.

16. The clamping device with coaxially rotating gripper pair as claimed in claim 1, wherein two sector type middle grippers (311) and (312) couple to two sockets with sector type recessed cylindrical sliding surfaces (308) installed at the clip jaw (100), the sector type middle grippers (311) and (312) individually has a middle socket with sector type recessed cylindrical sliding surface (318) on the clamping surface, in which each middle socket with sector type recessed cylindrical sliding surface (318) is individually installed with two coaxially rotating rotary grippers in sector type cylinder (101) and (102), whose diameters are smaller, and the clamping surfaces at two sides of the sector type middle grippers (311) and (312) and the clamping surface of the two coaxially rotating rotary grippers in sector type cylinder (101) and (102) together constitute the clamping device with clamping function, and thereby the clamping device and another clamping device with fixed shape constitute the clamping structure.

17. The clamping device with coaxially rotating gripper pair as claimed in claim 1, wherein two sector type middle grippers (311) and (312) couple to two sockets with sector type recessed cylindrical sliding surfaces (308) installed at the clip jaw (100), the sector type middle grippers (311) and (312) individually has a middle socket with sector type recessed cylindrical sliding surface (318) on the clamping surface, in which each middle socket with sector type recessed cylindrical sliding surface (318) is individually installed with two coaxially rotating rotary grippers in sector type cylinder (101) and (102), whose diameters are smaller, and the clamping surfaces at two sides of the sector type middle grippers (311) and (312) and the clamping surface of the two coaxially rotating rotary grippers in sector type cylinder (101) and (102) together constitute the clamping device with clamping function, while another clamping device is constituted by a clip jaw (400) with a socket with sector type recessed cylindrical sliding surface (408) and a coupled sector type gripper (401), and thereby said two clamping devices constitute the structure for opposite clamping.

18. The clamping device with coaxially rotating gripper pair as claimed in claim 1, wherein two sector type middle grippers (311) and (312) couple to two sockets with sector type recessed cylindrical sliding surfaces (308) installed at the clip jaw (100), the sector type middle grippers (311) and (312) individually has a middle socket with sector type recessed cylindrical sliding surface (318) on the clamping surface, in which each middle socket with sector type recessed cylindrical sliding surface (318) is individually installed with two coaxially rotating rotary grippers in sector type cylinder (101) and (102), whose diameters are smaller, and the clamping surfaces at two sides of the sector type middle grippers (311) and (312) and the clamping surface of the two coaxially rotating rotary grippers in sector type cylinder (101) and (102) together constitute the clamping device with clamping function, and thereby the clamping device and another clamping device with the same structure constitute the structure for opposite clamping.

19. The clamping device with coaxially rotating gripper pair as claimed in claim 1, wherein two sector type middle grippers (311) and (312) couple to two sockets with sector type recessed cylindrical sliding surfaces (308) installed at the clip jaw (100), the sector type middle grippers (311) and (312) individually has a middle socket with sector type recessed cylindrical sliding surface (318) on the clamping surface, in which each middle socket with sector type recessed cylindrical sliding surface (318) is individually installed with two coaxially rotating rotary grippers in sector type cylinder (101) and (102), whose diameters are smaller, and the clamping surfaces at two sides of the sector type middle grippers (311) and (312) and the clamping surface of the two coaxially rotating rotary grippers in sector type cylinder (101) and (102) together constitute the clamping device with clamping function, while another clamping device is constituted by a sector type middle gripper (511) couples to and rotates at a socket with sector type recessed cylindrical sliding surface (508) installed at a clip jaw (500), in which the clamping surface of the sector type middle gripper (511) has a middle socket with sector type recessed cylindrical sliding surface (518) for being installed with two coaxially rotating rotary grippers in sector type cylinder (101) and (102), whose diameters are smaller, and the clamping surface at two sides of the sector type middle gripper (511) and the clamping surface installed at the two coaxially rotating rotary grippers in sector type cylinder (101) and (102) of the middle socket with sector type recessed cylindrical sliding surface (518) together constitute the clamping device with clamping function, and thereby said two clamping devices constitute the structure for opposite clamping.

20. The clamping device with coaxially rotating gripper pair as claimed in claim 1, wherein the sector type middle gripper (311) couples to one of the two sockets with sector type recessed cylindrical sliding surfaces (308) installed at the clip jaw (100), the other socket with sector type recessed cylindrical sliding surface (308) is installed with the sector type gripper (302), and the clamping surface of the sector type middle gripper (311) has the middle socket with sector type recessed cylindrical sliding surface (318), in which the middle socket with sector type recessed cylindrical sliding surface (318) is installed with two coaxially rotating rotary grippers in sector type cylinder (101) and (102), whose diameters are smaller, and the clamping surface of the sector type middle gripper (311), the clamping surface of the two coaxially rotating rotary grippers in sector type cylinder (101) and (102), and the sector type gripper (302) together constitute the clamping device with clamping function, and said clamping device and another clamping device installed with the same clamping device at the clamping surface thereof are arranged in opposite, i.e. the clamping surfaces of the two sector type grippers (302) clamp in opposite, and the clamping surfaces of the sector type middle gripper (311), the two coaxially rotating rotary grippers in sector type cylinder (101) and the two coaxially rotating sector type cylinder rotary grippers (102) clamp in opposite, and thereby two clamping devices constitute the structure for opposite clamping.

21. The clamping device with coaxially rotating gripper pair as claimed in claim 1, wherein the sector type middle gripper (311) couples to one of the two sockets with sector type recessed cylindrical sliding surfaces (308) installed at the clip jaw (100), and the other socket with sector type recessed cylindrical sliding surface (308) installed at the clip jaw (100) is installed with the sector type gripper (302), and the clamping surface of the sector type middle gripper (311) has the middle socket with sector type recessed cylindrical sliding surface (318), in which the middle socket with sector type recessed cylindrical sliding surface (318) is individually installed with two coaxially rotating rotary grippers in sector type cylinder (101) and (102), whose diameters are smaller, and the clamping surface of the sector type middle gripper (311), the clamping surface of the two coaxially rotating rotary grippers in sector type cylinder (101) and (102), and the sector type gripper (302) together constitute the clamping device with clamping function, and said clamping device and another clamping device installed with the sector type gripper (302), the sector type middle gripper (311) and the two coaxially rotating rotary grippers in sector type cylinder (101) and (102), which is in opposite placement to said clamping device, at the opposite clamping surface thereof, i.e. rotary grippers the clamping surfaces of the sector type grippers (302) of the two clamping devices are respectively arranged to opposite clamp with the clamping surfaces at two sides of the sector type middle grippers (311) and the clamping surfaces of the two coaxially rotating rotary grippers in sector type cylinder (101) and (102), and thereby the two clamping devices constitute the structure for opposite clamping.

22. The clamping device with coaxially rotating gripper pair as claimed in claim 1, wherein two sector type middle grippers (311) and (312) couple to two sockets with sector type recessed cylindrical sliding surfaces (308) installed at the clip jaw (100), the sector type middle grippers (311) and (312) individually has a middle socket with sector type recessed cylindrical sliding surface (318) on the clamping surface, in which each middle socket with sector type recessed cylindrical sliding surface (318) is individually installed with two coaxially rotating rotary grippers in sector type cylinder (101) and (102), whose diameters are smaller, and the clamping surfaces at two sides of the sector type middle grippers (311) and (312) and the clamping surfaces of the two coaxially rotating rotary grippers in sector type cylinder (101) and (102) together constitute the clamping device with clamping function, and another clamping device is constituted by the clip jaw (300) installed with two sockets with sector type recessed cylindrical sliding surfaces (308), which is individually coupled with the sector type grippers (301) and (302), and thereby the two clamping devices constitute the structure for opposite clamping.

23. The clamping device with coaxially rotating gripper pair as claimed in claim 1, wherein which is installed with the two coaxially rotating rotary grippers in sector type cylinder (101) and (102), the moving coupling and restrictive structure of the two coaxially rotating rotary grippers in sector type cylinder (101) and (102) includes to use the moving coupling and the restrictive structure of the conventional sector type gripper and the socket with sector type recessed cylindrical sliding surface of the clip jaw, such as the structure of curved guide slot and limited pin.

24. The clamping device with coaxially rotating gripper pair as claimed in claim 1, wherein which includes the clamping structural unit constituted by the clip jaw and the two coaxially rotating rotary grippers in sector type cylinder (101) and (102) to be integrated with the clamping surface of the clamping device for clamping operation.

25. The clamping device with coaxially rotating gripper pair as claimed in claim 1, wherein which includes the gripper driven by human power, or hydraulic, pneumatic, or mechanical power, or electricity.

26. The clamping device with coaxially rotating gripper pair as claimed in claim 1, wherein which includes to be applied to the clamping structure, such as the clamp, gripping structure, pressurized construction, pliers, pipe clamp, hand-held gripping tool, mechanical arm, or is used for the supporting device of the unusual shape body.

27. The clamping device with coaxially rotating gripper pair as claimed in claim 1, wherein the clip jaw includes fixed or movable clip jaw, such as the clip jaw with fixed angle type structure and/or horizontally sliding clip jaw.
